(19) United States
(12) Patent Application Publication
(10) Pub. No.: US 2009/0261495 A1
(43) Pub. Date: Oct. 22, 2009

(54) METHOD FOR SETTING ACTION STEPS OF A MOLD CORE

(75) Inventors: CHIH-WEI HSIEH, Tu-cheng (TW); HSUAN-HUNG HSU, Tu-cheng (TW); WEI-CHU LAI, Tu-cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/233,830

(22) Filed: Sep. 19, 2008

(30) Foreign Application Priority Data
Apr. 16, 2008 (CN) 200810301138.X

(51) Int. Cl. B29C 45/80

(52) U.S. Cl. 264/40.5

(57) ABSTRACT

A method for setting action steps of a mold core, used in a mold core control system, the method comprising confirmation of the mold core for use. If mold cores are to be used, the number thereof is set. The control system implements action timing settings for every mold core, based on individual requirements. The new settings are confirmed, and if accepted, YES is entered and the action steps of the mold core are complete, and if not, NO is entered, and confirmation of the mold core for use is repeated.

### BACKGROUND

1. Field of the Invention

The invention generally relates to injection molding, and particularly to a method for setting action steps of a mold core.

2. Description of Related Art of the Invention

A typical mold core control system includes a human-machine interface. The mold core functions on the human-machine interface correspond to the design of the mold and can be very complicated. Accordingly, the operating interface of the mold core control system is not user-friendly. In addition, the interface cannot show the action steps of the mold core clearly, prompting user errors and damage to the mold.

What is needed, therefore, is a method for setting action steps of a mold core addressing the described limitations.

### BRIEF DESCRIPTION OF THE DRAWINGS

FIG. 1 is a diagram of a dialog box of a human-machine interface in accordance with an embodiment of the disclosure, showing a method for setting action steps of a mold core.

FIG. 2 is a block diagram of a method for setting action steps of a mold core in accordance with an embodiment of the disclosure.

### DETAILED DESCRIPTION OF THE EMBODIMENT

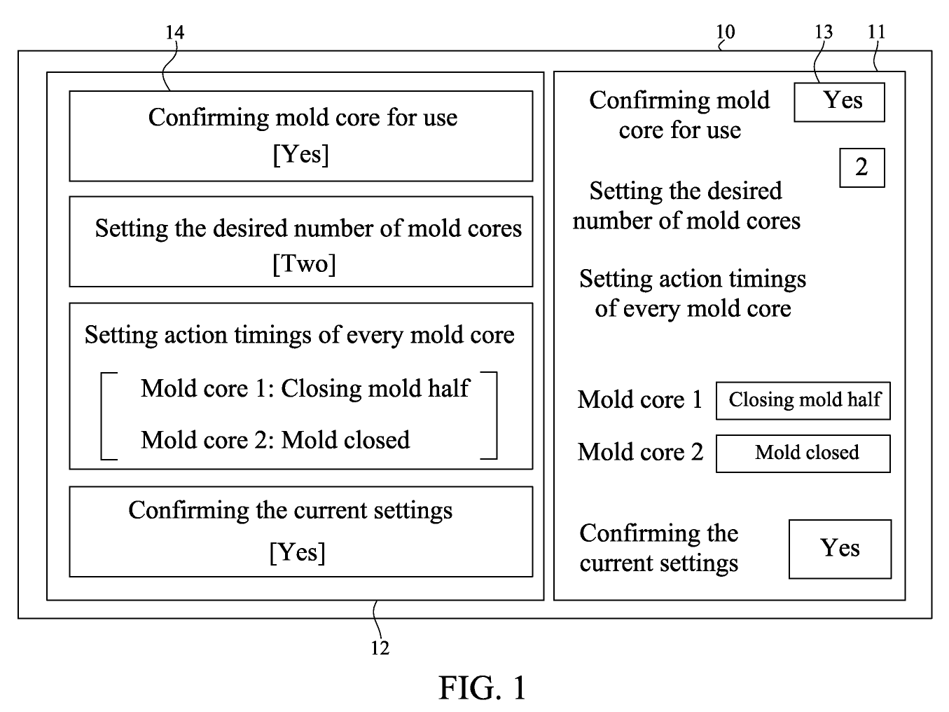

FIG. 1 is a diagram of a dialog box of a human-machine interface is shown. A method may be used to set action steps of a mold core for an injection molding machine including a control system (not labeled) having a display device (not labeled). The control system includes an interface module, which may produce a dialog box 10 having an input region 11 and a display region 12, which can be viewed through the display device. A user can input data or choose an option in input fields 13 of the input region 11, with display fields 14 of the display region 12 showing the result.

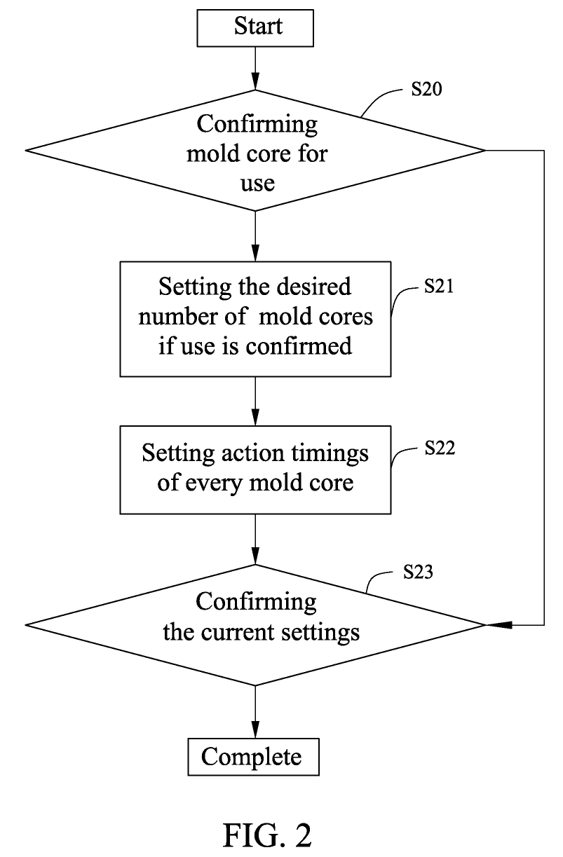

FIG. 2 is a block diagram of a method for setting action steps of a mold core. Depending on the embodiment, certain of the steps described below may be removed, others may be added, and the sequence of steps may be altered.

In a step S20, a selection of the mold cores for use is offered. If the selection is requested, the method continues to a step 21, and the number of mold cores for use is set. If not, the method continues to a step 23, and the setting is confirmed. In the illustrated embodiment, if the selection is requested, a confirmation prompt is generated.

In the step S21, if the mold cores are to be used, the number thereof is set and the method continues to a step 22 which sets an action timing for every mold core. For example, as shown in FIG. 1, the number “2” is inputted in the input field 13. Accordingly, the display field 14 shows the desired number of mold cores shown as “Two”. The action timing is the timing for the mold core starting action.

In the step S22, the control system implements an action timing setting of each mold core, based on individual requirements and continues to the step S23, when settings are confirmed. If the number of mold cores exceeds one, the action timings are set individually. For example, in FIG. 1, if “CLOSING MOLD HALF” is the action timing setting of each first mold core input field 13, the display field 14 shows “CLOSING MOLD HALF” for each first mold core. If “MOLD CLOSED” is inputted for the second mold core, the action timing of each second mold core, the display field 14 shows “MOLD CLOSED”. The “CLOSING MOLD HALF” is the mold core action when the mold closes to the half position. The “MOLD CLOSED” is the mold core action after the mold has closed.

In the step S23, the current settings are confirmed in a confirmation step, as shown in display region 12. For example, if the settings are accepted, a “YES” is entered and the action steps of the mold core are complete. Accordingly, the display field 14 shows “YES”. If not, “NO” is entered, and the method repeats itself and continues back to the step S20, and the selection of use of a mold core is repeated.

In the illustrated embodiment of FIG. 1, each input field 13 corresponds to one step, each display region 12 corresponds to one input region 11, and each input data of the input field 13 has a corresponding display field 14.

Finally, it is to be understood that the above-described embodiments are intended to illustrate rather than limit the invention. Variations may be made to the embodiment without departing from the spirit of the invention as claimed. The above-described embodiments illustrate the scope of the invention but do not restrict the scope of the invention.

What is claimed is:

1. A method for setting action steps of a mold core, the method comprising:
providing a mold core control system;
confirming the mold core for use;
setting a desired number of mold cores if use is confirmed;
setting action timings of each mold core; and
confirming current settings, wherein if the current settings are acceptable, the action steps of the mold core are complete; if the current settings are not acceptable, confirmation of the mold core for use is repeated.

2. The method as claimed in claim 1, wherein if the current settings are acceptable, a “YES” is entered; if the current settings are not acceptable, “NO” is entered.

3. The method as claimed in claim 1, wherein the control system includes an interface module comprising a dialog box having an input region and a display region, the input region and the display region are viewable through a display device.

4. The method as claimed in claim 1, wherein the input region comprises a plurality of input fields; the plurality of input fields corresponds to a plurality of display fields; the plurality of display fields are displayed in the display region.

5. The method as claimed in claim 4, wherein the input fields comprises:
confirming the mold core for use;
setting the desired number of mold cores;
setting action timings for each mold core;
confirming the current settings.

6. The method as claimed in claim 1, wherein, if the desired number of mold cores exceeds one, the action timings are set individually.

7. The method as claimed in claim 1, wherein, if the action timings are set individually, a “CLOSING MOLD HALF” and a “MOLD CLOSED” are entered, the “CLOSING MOLD HALF” is the mold core action when the mold closes to a half position, the “MOLD CLOSED” is the mold core action after the mold has closed.

8. The method as claimed in claim 1, wherein, if confirming the mold core for use is rejected, confirming the current settings step is executed, and the current settings are confirmed.
